(19) United States
(12) Patent Application Publication
(10) Pub. No.: US 2006/0024422 A1
(43) Pub. Date: Feb. 2, 2006

(54) Salt substitute compositions having N-neohexyl-a-aspartyl-l- phenylalanine methyl ester for modifying flavor and methods of manufacturing the same

(75) Inventor: Abraham Bakal, Margate, NJ (US)

Correspondence Address: STEINBERG & RASKIN, P.C., 1140 AVENUE OF THE AMERICAS, 15th FLOOR, NEW YORK, NY, 10036-5803, US

(73) Assignee: Cumberland Packing Corp.

(21) Appl. No.: 10/903,388

(22) Filed: Jul. 30, 2004

(51) Int. Cl. A23L 1/237

(52) U.S. Cl. 426/649

(57) ABSTRACT

A salt substitute composition is provided. The salt substitute composition has an amount of potassium chloride and an amount of N-[N-(3,3-dimethylbutyl)-L-α-aspartyl]-L-phenylalanine 1-methyl ester or neotame. The N-[N-(3,3-dimethylbutyl)-L-α-aspartyl]-L-phenylalanine 1-methyl ester is present in an amount of about 0.001 wt % to about 0.02 wt % of the total weight of the composition. The amount of N-[N-(3,3-dimethylbutyl)-L-α-aspartyl]-L-phenylalanine 1-methyl ester is optimized for reducing the undesired aftertaste of the potassium chloride.

### FIELD OF THE INVENTION

The present invention relates to low salt and salt substitute compositions. More particularly, the present invention relates to a salt substitute composition having potassium chloride and N-[N-(3,3-dimethylbutyl)-L-α-aspartyl]-L-phenylalanine 1-methyl ester, or neotame, wherein the neotame is present in an amount optimized for masking the metallic taste of potassium chloride in the salt substitute composition.

### DESCRIPTION OF THE PRIOR ART

The use of salt, or sodium chloride (NaCl), as a seasoning to enhance the taste of food predates recorded history. Salt is used to make bland food more palatable and to bring out the natural flavors in other foods. Salt has also been used for centuries to preserve meat, fish and dairy products.

In addition to its culinary uses, salt is an essential mineral component necessary to a healthy diet. Salt helps the body to perform vital functions such as enabling the transmission of nerve impulses to and from the brain, aiding the contractions of the heart and other muscles, aiding in digestion, and assisting the movement of nutrients around the body. Excess sodium intake alters the salt/water balance in the human body, causing water retention.

Individuals with medical issues such as congestive heart failure, hypertension and kidney disease are extremely sensitive to salt intake. For these individuals excess salt intake and resultant water retention can lead to an increase in blood pressure as well as excess fluid in the bloodstream. Thus, health professionals generally recommend a reduction in salt intake for individuals suffering from such medical conditions.

Low salt or light salt compositions and salt substitute compositions are well known in the art. Low salt or light salt compositions and salt substitute compositions are alternative seasoning options that provide means for replacing or reducing the amount of sodium chloride required to season foods. Low salt or light salt compositions typically comprise a mixture of potassium chloride and sodium chloride. Salt substitute compositions employ potassium chloride as the primary salt substitute component. However, existing low salt and salt substitute compositions, particularly those employing potassium chloride, have not successfully paralleled the taste of table salt.

Potassium chloride is characterized by an acrid, bitter or metallic taste. Moreover, the salt taste perception of potassium chloride is very low. In order to overcome the taste problems associated with potassium chloride, numerous additive ingredients have been employed in an effort to modify its taste and to mask the bitter or metallic aftertaste. Materials that have been added to modify the taste of potassium chloride include salts and acidifiers including, but not limited to, potassium bitartrate, food acids such as citric, malic, tartaric, fumaric, and magnesium chloride, magnesium sulfate, tricalcium phosphoate and combinations thereof. For example, U.S. Pat. No. 4,068,006 discloses a low salt formulation having a potassium chloride mixed with sodium chloride and containing a citric acid as a bitterness suppressor for the potassium chloride taste.

Other means of masking the taste of potassium chloride include using amino acids such as glutamic acid, potassium glutamate, and l-lysine. U.S. Pat. No. 5,897,908 discloses a salt substitute composition containing a mixture of lysine monohydrochloride and potassium chloride, and a succinic acid additive, which produces a salty taste.

Additional means of altering the taste of potassium chloride have included the use of taste modifiers or flavors such as lemon flavor, proprietary flavor combinations and spices. Further means of altering the taste of potassium chloride include the use of astringent compounds such as tannic acid. However, it is generally recognized that while the above-described attempts offer some minor improvement in the taste of potassium chloride containing salt substitutes, these salt substitutes have not successfully masked the bitter or metallic aftertaste associated with non-salt components such as potassium chloride. Salt substitutes containing potassium chloride continue to exhibit a strong aftertaste. Moreover, some of the additive ingredients used in the prior art to mask the taste of potassium chloride have been shown to cause adverse reactions such as allergies, asthma and headaches is some individuals.

Due to the unsatisfactory taste and other issues associated with current low salt and salt substitute compositions, use of low salt and salt substitutes is frequently limited to consumers who, because of health concerns, are highly motivated to reduce or eliminate salt intake. There is, therefore, a clear need for a low-salt or salt substitute composition that successfully masks the bitter taste of non-salt components such as potassium chloride and meets the needs of consumers who must restrict their sodium intake.

The use of N-neohexyl-α-aspartyl-l-phenylalanine methyl ester, or neotame, as a sweetener is known. U.S. Pat. No. 5,480,668 discloses that neotame is approximately 8,000 times as sweet as sucrose, on a weight basis. Replacing part of the sweetener in traditional or sugar-free confectionary compositions with neotame offers increased sweetness and flavor. Thus, neotame has been used alone or in combination with other non-nutritive or nutritive sweeteners thereby reducing or replacing the sugar and caloric content of confectionary products.

U.S. Pat. No. 6,368,651 describes the use of neotame to replace a bulk sweetener such as sugar in a food or beverage. The patent further describes the use of additives for modifying the high intensity sweetening characteristics of neotame.

Moreover, U.S. patent application Publication No. 2003/0008046 A1 discloses the use of neotame for modifying, improving and/or enhancing the overall flavor or aroma of ingestible compositions such as beverages and confectionery products.

What is not appreciated by the prior art is the use of neotame in an amount that is optimized for successfully masking metallic taste in low salt or salt substitute compositions. The present salt substitute composition overcomes this deficiency by providing specific ranges in which neotame is optimized for masking the metallic taste of potassium chloride in low salt and salt substitute compositions.

### SUMMARY OF THE INVENTION

In accordance with the present invention, it has been found that the addition of a specific amount of neotame to a salt substitute having potassium chloride modifies the taste of potassium chloride by eliminating or substantially reducing the aftertaste of the salt substitute and increasing the perception of the saltiness level of the potassium chloride.

It is thus a primary object of the present invention to provide a low salt or salt substitute composition.

It is another object of the present invention to provide a low salt or salt substitute composition containing potassium chloride.

It is a yet another object of the present invention to provide a low salt or salt substitute composition containing potassium chloride wherein neotame is added in an amount optimized for eliminating the bitter aftertaste of potassium chloride and increasing the saltiness of potassium chloride as a flavor.

It is still another object of the present invention to provide a low salt or salt substitute composition containing potassium chloride and neotame, wherein neotame is present in an amount of about 0.001 wt % to about 0.02 wt % of the total weight of the composition.

It is a yet another object of the present invention to provide a low salt or salt substitute composition containing potassium chloride and neotame, wherein neotame is present in an amount of about 0.001 wt % to about 0.015 wt % of the total weight of the composition.

It is a further object of the present invention to provide a method of manufacturing a low salt or salt substitute composition wherein neotame is present in an amount optimized for eliminating the bitter aftertaste of potassium chloride and for enhancing the intensity of salt flavor as perceived by a consumer.

These and other objects and advantages of the present invention are achieved by the salt substitute composition according to the present invention. The salt substitute composition has N-[N-(3,3-dimethylbutyl)-L-α-aspartyl]-L-phenylalanine 1-methyl ester, and potassium chloride having an undesired aftertaste, wherein said N-[N-(3,3-dimethylbutyl)-L-α-aspartyl]-L-phenylalanine 1-methyl ester is present in an amount of about 0.001 wt % to about 0.02 wt % of the total weight of the composition, and wherein said amount of N-[N-(3,3-dimethylbutyl)-L-α-aspartyl]-L-phenylalanine 1-methyl ester is optimized for reducing the undesired aftertaste and for enhancing the perceived salt flavor of potassium chloride.

Other objects and advantages of the present invention will be apparent from a further reading of the specification and the appended claims.

### DETAILED DESCRIPTION OF THE INVENTION

N-[N-(3,3-dimethylbutyl)-L-α-aspartyl]-L-phenylalanine 1-methyl ester or neotame is an intense sweetener that has been recently approved by the FDA. Neotame is and has the formula

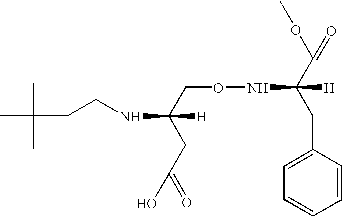

The present invention relates to the use of N-[N-(3,3-dimethylbutyl)-L-α-aspartyl]-L-phenylalanine 1-methyl ester, or neotame, to modify the flavor, that is the taste and/or aroma properties, of low salt or no-salt compositions. For the purposes of this invention, flavor is the combined taste and smell sensation evoked by a food substance, as perceived by a consumer.

The neotame used in this invention may take any form. For example, it may be a salt or complex such as described in U.S. Pat. No. 6,291,004, U.S. Pat. No. 6,180,156, U.S. Pat. No. 6,129,942, U.S. Pat. No. 6,146,680, U.S. Pat. No. 6,214,402, and U.S. Provisional Patent Application No. 60/126,363, the disclosures of which are incorporated by reference herein. Other exemplary forms of neotame that may be used in this invention include co-crystallized forms and cyclodextrin complexes, such as described in U.S. Pat. No. 6,214,402 and U.S. Provisional Patent Application No. 60/100,867, the disclosures of which are incorporated by reference herein.

It has been found, through experimentation, that a specific amount of neotame is required for its successful use in optimizing the flavor of a potassium chloride salt substitute. When the amount of neotame added to an amount of potassium chloride is optimized, the bitter aftertaste of potassium chloride is eliminated. Additionally, the saltiness flavor of potassium chloride is increased. By contrast, when the amount of neotame added to an amount of potassium chloride is not optimized, the resultant salt substitute may be too sweet or too bitter for effective use as a salt-substitute. For example, when the amount of neotame added to an amount of potassium chloride in a salt substitute composition is below the optimized amount, the neotame does not have the capacity to counteract the inherent bitterness of the potassium chloride in the salt substitute. Moreover, when the amount of neotame added to an amount of potassium chloride in a salt substitute composition is above the optimized amount, the salt substitute will be perceived as sweet.

The salt substitute composition of the present invention contains potassium chloride and an amount of neotame optimized for masking the bitter aftertaste and increasing the saltiness flavor of the potassium chloride. Preferably, the amount of neotame in the salt substitute of the present invention is between 1 mg of neotame per 100 g of potassium chloride and 20 mg of neotame per 100 g of potassium chloride. Accordingly, neotame is preferably present in an amount about 0.001 percentage by weight (wt. %) to about 0.02 wt. % of the total weight of the compositions of the present invention. The ratio of neotame to potassium chloride is preferably from about 1:999,990 to about 1:4,999.

In a more preferred composition of the present invention, the amount of neotame is between 5 mg of neotame per 100 g of potassium chloride and 15 mg of neotame per 100 g of potassium chloride. More specifically, neotame is preferably present in an amount about 0.005 percentage by weight (wt. %) to about 0.015 wt. % of the total weight of the composition of the present invention. Thus, the ratio of neotame to potassium chloride is preferably from about 1:20,000 to about 1:6,667.

The low salt or salt substitute composition of the present invention may have one or more additional salt substitute components. Such salt substitute components include, by non-limiting example, sodium chloride, sodium sulphate, potassium phosphate, calcium phosphate, sodium tripolyphosphate, sodium bicarbonate, sodium carbonate, potassium carbonate, calcium carbonate, potassium hydrogen carbonate, calcium chloride-dihydrate, and any combinations thereof.

The salt substitute composition can also include one or more additional additive components such as texturizers, fillers and preservatives. Suitable additive components may include maltodextrin, starch (such as corn, tapioca, rice, potato), pregelatinized starch (such as corn, rice tapioca, potato), magnesium chloride, magnesium sulfate, potassium bitartrate, acidifiers (such as citric acid, tartaric acid, fumaric acid) and amino acids (such as lysine, glutamic acid), color, preservatives and any other food additive known in the art.

In order to provide the consumer with a predictable flavoring result, neotame must be uniformly distributed in the salt substitute composition. Several non-limiting methods of manufacture of the salt substitute of the present invention, which provide uniform distribution of neotame in the salt substitute are discussed.

A first method of manufacture requires a step of solubilizing one or more salt substitutes, neotame, and any additional components in a solvent. The solvent is preferably water. The solubilized solution is then dried in any manner known in the art. Non-limiting examples of suitable drying methods include tray drying, vacuum drying, spray drying, freeze drying and foam mat drying. The preferred drying methods are tray or belt drying and spray drying.

A second method of manufacturing a uniform salt substitute product containing the desired amount of neotame requires diluting neotame prior to solubilization. A mixture of 98 or 99 parts by weight of 10 Dextrose Equivalent (DE) maltodextrin is mixed with one or two parts of neotame to form a diluted neotame mixture. The diluted neotame mixture is then solubilized, preferably with water, to form about 50% solution. The solubilized solution is then spray dried. A 1% to 2% neotame product is thus obtained. Potassium chloride is then admixed with the spray-dried neotame/maltoderin mixture to form a uniform salt substitute product.

A third method of manufacturing a uniform salt substitute requires an agglomeration step. One such method requires solubilizing an amount of neotame, preferably in water, to obtain a solution. The solution is then sprayed onto a mixture of pregelatinized starch or maltodextrin and potassium chloride in a fluidized bed agglomerator such as that manufactured by Glatt® of Germany. The pregelatinized starch or maltodextrin acts as a binder for the potassium chloride mass. The agglomeration process yields large particles, some of which have surface neotame. The large particles have an untapped bulk density of between 0.35 to 0.55 g/cc. Particle size distribution is characterized by less than 18% of the large particles passing through a 200 mesh screen. Thus, neotame, formerly disposed in the spray solution is, following agglomeration, either captured within or adhered to the pregelatinized starch or maltodextrin particles and the potassium chloride.

An alternate agglomeration method requires mixing potassium chloride powder with pregelatinized starch or maltodextrin powder and neotame powder and agglomerating the mixture using an agglomerator. Moisture that is added to the mixture during agglomeration is later removed by any drying method known in the art.

The Examples, which follow, are intended as an illustration of certain embodiments of the invention, and no limitation of the invention is implied thereby.

Several food compositions were analyzed for flavor. Flavor was rated based upon the taste perceptions of an expert panel of ten tasters regarding the consumption of the defined product. The tasters were selected for the panel on the basis of their acuity to basic tastes including sweetness, saltiness, sourness and bitterness.

Flavor was measured using a flavor rating scale wherein a rating of 0 indicates no perceived flavor and a rating of 8 indicates a very strong perceived flavor. The flavor sensations specifically analyzed in the Examples below were saltiness and bitterness. Thus, for example, a score of 0 for bitterness indicates that the taster detected no bitterness in the sample. The overall rating score was achieved by calculating the average of the rating values provided by the expert panelists.

### EXAMPLE 1

A salt substitute mixture of 950 parts of potassium chloride and 50 parts of cream of tartar was prepared. This salt substitute product was evaluated by adding 1 g of salt substitute to 99 g of mashed potato and 1 g of salt substitute to 99 g of chopped tomatoes and cucumbers. Foods seasoned with the potassium chloride preparation were evaluated for the level of saltiness and bitterness. The average rating score was 7 for bitterness and 1 for saltiness. Thus, the salt substitute was found to have very slight perceived saltiness and very strong bitterness.

### EXAMPLE 2

Samples of commercial salt substitutes Nu-Salt™ and No Salt™, available in the market, were evaluated for saltiness and bitterness flavor using the flavor rating scale. The salt substitutes Nu-Salt™ and No Salt™ were rated as having very low saltiness perception and strong bitterness. The results are shown in the Table 1 below.

TABLE 1

| Product | Saltiness | Bitterness |
|---|---|---|
| Nu-Salt ™ | 1 | 6 |
| No Salt ™ | 1.5 | 5.5 |

### EXAMPLE 3

1 part by weight of neotame was mixed with 99 parts by weight of maltodextrin 10DE. This mixture was solubilized in an equal part of water to yield 50% solids solution. The solution was spray-dried to yield 1% neotame encapsulated in 99% maltodextrin. A salt substitute was then prepared by mixing 99.5 g of potassium chloride and 1 g of the encapsulated neotame. The salt thus effectively contained 10 mg of neotame per 100 parts of salt. The salt substitute was evaluated using the flavor rating scale. The saltiness rating score was 3.5. The bitterness rating score was 3. Thus, this salt substitute was found to have a flavor that closely parallels the flavor of salt.

### EXAMPLE 4

5 parts by weight of pregelatinized starch (rice starch) was mixed with 99.5 parts of potassium chloride. 10 mg of neotame was solubilized in 200g of water and this solution was sprayed on the pregelatinized starch/potassium chloride powder in a Glatt® fluidized bed agglomerator. As a result, an agglomerated salt substitute was obtained that contained 95% potassium chloride, 5% pregelatinized starch and 10 mg of neotame per 100 g of powder. This salt substitute was evaluated based on the flavor rating scale described above. The results indicated a significant increase in the saltiness perception (rating score 5) and a significant reduction in bitterness (rating score 2.5).

### EXAMPLE 5

98 parts by weight of the salt substitute of example 4 was mixed with 2 parts by weight of citric acid. This product was evaluated based on the flavor rating scale described above. The saltiness rating score was 5.5. The bitterness rating score was 2. The same test was performed substituting fumaric acid for the citric acid, in the same amounts. While there was a reduction in bitterness and an increase in saltiness in the composition having fumaric acid, fumaric acid was judged as less effective than citric acid.

### EXAMPLE 6

97.2 parts by weight of the salt substitute of Example 4 was mixed with 2.8 parts by weight of L-lysine. This product was evaluated based on the flavor rating scale described above. The results indicated that the saltiness rating score was 5 and the bitterness rating score was 2.5. L-lysine at levels lower than 2.8 parts were less effective.

### EXAMPLE 7

Several combinations of potassium chloride and neotame employing the agglomeration process described in Example 4 were evaluated. 10 mg of neotame to 100 parts of potassium chloride resulted in an increase in saltiness, but also resulted in an undesired perceived level of sweetness. This product was thus found inferior to the product of Example 4. 10 mg of neotame to 90 parts of potassium chloride and 10 parts of maltodextrin 10 DE also resulted in an increased level of saltiness and a perceived level of sweetness. This product was thus found inferior to the product of Example 4.

### EXAMPLE 8

95 g of potassium chloride were solubilized in 100 g of water. 5 g of pregelatinized starch and 10 mg of neotame were added to the solution. The solution was then dried using air-drying such as oven drying or spray drying. The resulting salt substitute composition contained 95 g of potassium chloride, 5 g of pregelatinized starch and 10 mg of neotame. This salt substitute composition was rated and received similar scores as did the composition of Example 5.

95 g of potassium chloride were solubilized in 100 g of water. 5 g of pregelatinized starch and 5 mg of neotame were added to the solution. The solution was then dried using air-drying such as oven drying or spray drying. The resulting salt substitute composition contained 95 g of potassium chloride, 5 g of pregelatinized starch and 5 mg of neotame. This salt substitute composition was evaluated based on the flavor rating scale described above and found to closely parallel the taste of salt. The composition received a saltiness rating score of 4.5 and a bitterness rating score of 3.

### EXAMPLE 9

98 g of potassium chloride and 2 g of gum Arabic were solubilized in 100 g of water. To this solution, 10 mg of neotame were added. The salt substitute was dried and the resulting product was evaluated based on the flavor rating scale described above. The composition had a saltiness rating score of 5 and a bitterness rating score of 3.

95 g of potassium chloride and 5 g of gum Arabic were solubilized in 100 g of water. To this solution, 10 mg of neotame were added. The salt substitute was dried and the resulting product was evaluated based on the flavor rating scale described above. The composition had a saltiness rating score of 5 and a bitterness rating score of 3.

While the invention has been described in terms of preferred embodiments and specific examples, other variations or modifications that those skilled in the art will recognize through routine experimentation are within the scope and teachings of this invention. This invention is not to be limited except as set forth in the following claims.

What is claimed is:

1. A salt substitute composition, said composition comprising N-[N-(3,3-dimethylbutyl)-L-α-aspartyl]-L-phenylalanine 1-methyl ester, and potassium chloride having an undesired aftertaste, wherein said N-[N-(3,3-dimethylbutyl)-L-α-aspartyl]-L-phenylalanine 1-methyl ester is present in an amount of about 0.001 wt % to about 0.02 wt % of the total weight of the composition, and wherein said amount of N-[N-(3,3-dimethylbutyl)-L-α-aspartyl]-L-phenylalanine 1-methyl ester is optimized for reducing the undesired aftertaste of said potassium chloride.

2. The composition of claim 1, wherein the ratio of said N-[N-(3,3-dimethylbutyl)-L-α-aspartyl]-L-phenylalanine 1-methyl ester to said potassium chloride is preferably from about 1:999,990 to about 1:4,999.

3. The composition of claim 1, wherein said composition further comprises one or more components selected from the group consisting of sodium chloride, sodium sulphate, potassium phosphate, calcium phosphate, sodium tripolyphosphate, sodium bicarbonate, sodium carbonate, potassium carbonate, calcium carbonate, potassium hydrogen carbonate, calcium chloride-dihydrate, and any combinations thereof.

4. The composition of claim 1, wherein said composition further comprises one or more components selected from the group consisting of sodium chloride, maltodextrin, starch, pregelatinized starch, magnesium chloride, magnesium sulfate, potassium bitartrate, acidifiers, amino acids, and any combinations thereof.

5. The composition of claim 4, wherein said starch is selected from the group consisting of corn, tapioca, rice, potato, and any combinations thereof.

6. The composition of claim 4, wherein said pregelatinized starch is selected from the group consisting of corn, tapioca, rice, potato, and any combinations thereof.

7. The composition of claim 4, wherein said acidifier is selected from the group consisting of citric acid, tartaric acid, fumaric acid, and any combinations thereof.

8. The composition of claim 4, wherein said amino acid is selected from the group consisting of lysine, glutamic acid and any combinations thereof.

9. The composition of claim 1, wherein the composition is a powder.

10. A salt substitute composition, said composition comprising N-[N-(3,3-dimethylbutyl)-L-α-aspartyl]-L-phenylalanine 1-methyl ester, and potassium chloride having an undesired aftertaste, wherein said N-[N-(3,3-dimethylbutyl)-L-α-aspartyl]-L-phenylalanine 1-methyl ester is present in an amount of about 0.005 wt % to about 0.015 wt % of the total weight of the composition, and wherein said amount of N-[N-(3,3-dimethylbutyl)-L-α-aspartyl]-L-phenylalanine 1-methyl ester is optimized for reducing the undesired aftertaste of said potassium chloride.

11. The composition of claim 10, wherein the ratio of said N-[N-(3,3-dimethylbutyl)-L-α-aspartyl]-L-phenylalanine 1-methyl ester to said potassium chloride is preferably from about 1:20,000 to about 1:6,667.

12. The composition of claim 10, wherein said composition further comprises one or more components selected from the group consisting of sodium chloride, sodium sulphate, potassium phosphate, calcium phosphate, sodium tripolyphosphate, sodium bicarbonate, sodium carbonate, potassium carbonate, calcium carbonate, potassium hydrogen carbonate, calcium chloride-dihydrate, and any combinations thereof.

13. The composition of claim 10, wherein said composition further comprises one or more components selected from the group consisting of maltodextrin, starch, pregelatinized starch, magnesium chloride, magnesium sulfate, potassium bitartrate, acidifiers, amino acids, and any combinations thereof.

14. The composition of claim 13, wherein said starch is selected from the group consisting of corn, tapioca, rice, potato, and any combinations thereof.

15. The composition of claim 13, wherein said pregelatinized starch is selected from the group consisting of corn, tapioca, rice, potato, and any combinations thereof.

16. The composition of claim 13, wherein said acidifier is selected from the group consisting of citric acid, tartaric acid, fumaric acid, and any combinations thereof.

17. The composition of claim 13, wherein said amino acid is selected from the group consisting of lysine, glutamic acid and any combinations thereof.

18. The composition of claim 10, wherein the composition is a powder.

19. A method of manufacturing a salt substitute composition comprising the steps of:
solubilizing an amount of potassium chloride in a solvent;
solubilizing an amount of N-[N-(3,3-dimethylbutyl)-L-α-aspartyl]-L-phenylalanine 1-methyl ester in a solvent;
mixing said solubilized potassium chloride and said solubilized N-[N-(3,3-dimethylbutyl)-L-α-aspartyl]-L-phenylalanine 1-methyl ester to form a solution; and
drying said solution, wherein said N-[N-(3,3-dimethylbutyl)-L-α-aspartyl]-L-phenylalanine 1-methyl ester is present in an amount about 0.001 wt % to about 0.02 wt % of the total weight of the composition.

20. A method of manufacturing a salt substitute composition comprising the steps of:
forming a mixture comprising N-[N-(3,3-dimethylbutyl)-L-α-aspartyl]-L-phenylalanine 1-methyl ester and a carrier;
solubilizing said mixture in water to form a solubilized mixture;
spray-drying said solubilized mixture to form a spray-dried product; and
mixing said spray-dried product with potassium chloride,
wherein said N-[N-(3,3-dimethylbutyl)-L-α-aspartyl]-L-phenylalanine 1-methyl ester is present in an amount about 0.001 wt % to about 0.02 wt % of the total weight of the composition.

21. The method of claim 20, wherein said carrier is maltodextrin.

22. A method of manufacturing a salt substitute composition comprising the steps of:
solubilizing N-[N-(3,3-dimethylbutyl)-L-α-aspartyl]-L-phenylalanine 1-methyl ester in water to form a solution;
mixing potassium chloride and a starch to form a powder;
spraying said solution onto said powder; and
agglomerating said solution and said powder using a fluidized bed agglomerator,
wherein said N-[N-(3,3-dimethylbutyl)-L-α-aspartyl]-L-phenylalanine 1-methyl ester is present in an amount about 0.001 wt % to about 0.02 wt % of the total weight of the composition.
